(19) United States
(12) Patent Application Publication
(10) Pub. No.: US 2009/0196794 A1
(43) Pub. Date: Aug. 6, 2009

(54) APPARATUS AND METHOD FOR RAPID HEAT TRANSFER STERILIZATION

(76) Inventors: William Smith, Bloomington, IL (US); Nelson Slavik, Niles, MI (US)

Correspondence Address: MICHAEL BERNS;MALONEY, PARKINSON AND BERNS, 135 W MAIN STREET, URBANA, IL, 61801, US

(21) Appl. No.: 12/024,483

(22) Filed: Feb. 1, 2008

(51) Int. Cl. B01J 19/00

(52) U.S. Cl. 422/82.12

(57) ABSTRACT

A device and method is disclosed for sterilizing objects, commonly dental, medical, or veterinary instruments. By subjecting the objects to heat, the objects are sterilized quickly and more conveniently. The invention allows for user controls and treatment cycles to suit the needs of the sterilizing industry.

### BACKGROUND OF THE INVENTION

1. Field of Invention

The present invention relates to an apparatus and method for sterilization of items. These may be instruments used in medical, dental, veterinary, or other markets, or for the sterilization of other items. There is a need for a device to quickly sterilize objects, such as medical instruments in an operating room.

Currently, steam sterilization is used in the operating room to sterilize critical instruments or other devices in time of critical need by “flashing” steam to the instrument or other device. The time-temperature profiles required for sterilization assurance of such a technique are often not evaluated and have led to instruments and devices remaining contaminated after treatment. The “flash sterilization” technique is not recommended, but in times of critical instrument or device need, it is the only relatively quick method available to the operating room.

U.S. Pat. No. 4,923,681 issued May 8, 1990 to Cox et al. discloses a High Velocity Hot Air Sterilization Device with Controller. The technology has the potential to meet the critical care needs of the operating room, but the products distributed using this technology achieved very limited commercial success because of inadequacies that did not meet the needs and requirements of the hospital marketplace.

The present invention serves to remedy these inadequacies by incorporating additional features that have been determined to be essential by medical, dental, and veterinary personnel to ensure the time and temperature thresholds are met to meet sterilization criteria during the sterilizer's operation.

2. Description of Prior Art

U.S. Pat. No. 4,923,681 issued May 8, 1990 to Cox et al. discloses a High Velocity Hot Air Sterilization Device with Controller. This device was designed and marketed for use in the dental office to rapidly sterilize small instruments without instrument corrosion. The unit designed was small, built to accommodate the smaller dental instruments and the reduced volume of instruments requiring sterilization at any one time. The unit was designed having three sterilization time cycles: (1) for unwrapped instruments, (2) for air rotor hand pieces or for instruments with air or water tubing, and (3) for wrapped instruments, all three at 375° F. Although sterilization cycle times were pre-set and monitored by a countdown timer and an audio alarm at the completion of the cycle, the sterilizer drawer could be opened and instruments removed prior to the completion of the sterilization cycle.

Although the primary mechanism of rapid sterilization via high velocity hot air flow lent itself to use other medical and veterinary markets, there was limited success in penetrating those markets. Market research to evaluate this limited success determined that the size of the unit, the ability to easily interrupt a sterilization cycle and retrieve an instrument prior to the fulfillment of sterilization criteria, and the singular high temperature of 375° F. which prevented the use of the sterilizer for instruments that were temperature sensitive at elevated temperatures were the major factors for this limited success in the healthcare market.

The need exists for a high velocity hot air sterilization device that can provide for the sterilization of instruments within the operating room in a timely manner to meet patient and physician critical care needs with the sterilization assurance for a variety of instruments exhibiting varying temperature sensitivities.

### SUMMARY OF THE INVENTION

The present invention provides a rapid transfer dry-heat sterilization method for sterilizing medical, dental, or veterinary instruments or other devices or for other purposes. It is the object of the invention to provide a new type of sterilization device to overcome the problems of the prior art embodied in the invention of Cox et al. More specifically: (1) the ability to provide assurance that the pre-set treatment cycles cannot be breached or interrupted, (2) the ability to provide a variety of pre-set and Food and Drug Administration approved time-temperature settings to accommodate heat labile instruments, and (3) the ability to provide mechanisms to automatically record and store permanent records of all sterilization cycles and their operating conditions.

The sterilization device operation is under the control of a programmable controller which provides for maintaining the pre-set time-temperature conditions for varying instrument sensitivities and assurance monitoring of all sterilization cycle conditions. Additionally, the controller acts to control the entry into the sterilizer chamber during a sterilization cycle by controlling the chamber door locking mechanism. The controller provides the data required for the automatic recording and creation of permanent records of each sterilization cycle.

To compensate for processing non-metallic and heat-sensitive instrumentation and devices, the sterilization device incorporates several time-temperature profile settings that have been established as meeting sterilization conditions established by the Food and Drug Administration. Temperatures incorporated into these pre-established settings range from 250° F. to 400° F. with corresponding established timeframe thresholds required to meet the criteria of sterilization. These pre-established settings have time sub-settings for both wrapped and unwrapped instruments. The temperatures and times required for these established settings are programmed and monitored via a digitally programmable controller.

To indicate the selected settings for each cycle's start and finish time, each cycle's treatment time, each cycle's temperature, and cycle settings, the sterilizer incorporates variable parametric control settings and visible readouts.

To preclude the ability to breach or interrupt the sterilization cycle and retrieve an instrument before sterilization conditions have been met, the sterilization device has incorporated a sterilization door locking mechanism. Once the instrument tray has been inserted into the sterilization chamber and the treatment cycle initiated, the controller initiates the locking mechanism to prevent the door from being opened until the completion of the cycle.

To provide for circumstances that may occur that once the sterilization cycle has been initiated, it may be necessary to terminate the cycle and retrieve the instrument or re-program the settings. In this event, the sterilization cycle is terminated by activating the “Cycle Terminate” setting (over-ride control) and the drawer is unlocked. An audible alarm sounds to alert the medical personnel of the premature cycle interruption and the printer is then activated to record that the sterilization cycle was interrupted and incomplete.

To ensure that the internal critical components of the sterilizer are properly functioning, the controller has the ability via an air-flow monitor to monitor the proper air-flow rate across the entire instrument tray assuring proper heat transfer to the affected instruments.

To provide a means for both direct temperature monitoring, the controller has the ability to monitor sensors such as thermocouples and non-contact temperature monitoring devices using infrared or other such sensors (Adjustable Irt/c.4ACF and c.8ACT model IR thermocouple sensors), including non-contact temperature sensors employed to monitor the surface temperature of instruments or instrument surrogates.

To assist in energy savings and to have the sterilizer “at temperature” when needed, the sterilization device has the ability to provide programmable “Off” and “Resting” modes linked to an atomic clock to bring the sterilization device from off to resting to treatment temperature and to turn the unit down to “Resting” or “Off” mode at selective times automatically as programmed for each day of the week.

To meet mandated sterilization recordkeeping requirements, the sterilization device also incorporates the ability to record, store and print a permanent ink record including date, start-time and end-time, cycle number, cycle setting, treatment temperature, total treatment time, time at designated temperature, and note any possible interruption or malfunction within each cycle.

To facilitate instrument removal or instrument tray removal or insertion, the sterilizer device incorporates a door linked to the instrument tray that partially pulls out the instrument tray for loading and unloading.

### BRIEF DESCRIPTION OF THE DRAWINGS

In describing the invention, reference will be made to the accompanying drawings in which:

FIG. 1 is an isometric view of a preferred embodiment of the high velocity hot air sterilization device;

FIG. 2 is a cross-sectional view of the high velocity hot air sterilization device; and

FIG. 3 is an isometric view of the sliding tray and door.

### DETAILED DESCRIPTION OF THE PREFERRED EMBODIMENTS

The present invention provides a sterilization unit that utilizes high velocity dry air heat to sterilize items and meet the requirements of medical, veterinary, and dental operators for sterilization assurance for a variety of instruments exhibiting varying temperature sensitivities.

The embodiments of the invention may have the following features:

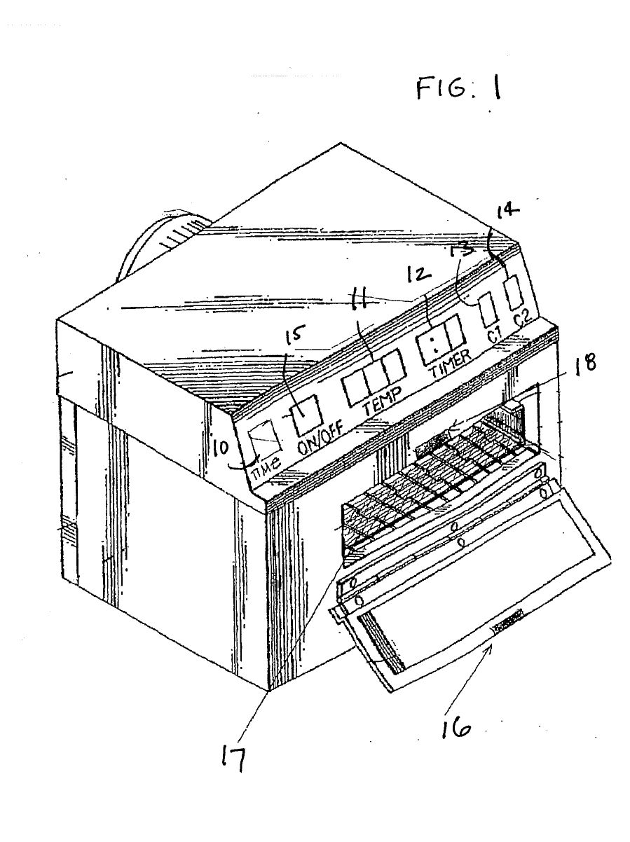

Referring to the drawings, and in particular, FIG. 1, the preferred embodiment of the invention is produced with a washable, stainless steel housing. Controls and monitors are provided in the embodiment to allow the user to turn the unit on/off and monitor time, temperature, and air flow and operate a multitude of sterilizing cycles.

As shown in FIG. 1, the clock 10, the temperature indicator panel 11 and timer 12, show the status of pre-set cycle settings determine the time and temperature requirements necessary to preserve the material integrity and to meet sterilization requirements for instruments and devices of various metal and plastic compositions, both wrapped and unwrapped. These settings having a range in temperature from 250° F. to 400° F. with corresponding established timeframe thresholds are pre-determined for a variety of material compositions and pre-set into the software of the sterilizer. Upon completion of the sterilization cycle a distinct audible alarm is activated.

As shown in FIG. 1, the temperature indicator panel 11 displays the internal temperature of the sterilization chamber from the time the unit is turned on.

As shown in FIG. 1, the unit is equipped with a battery-powered atomic clock 10 to ensure date, start-times, and end-times are accurate and a low-battery light 13.

The unit of the invention may be equipped with programmable “Off” and “Resting” modes linked to the atomic clock 10 at selective times automatically as programmed for each day of the week.

As shown in FIG. 1, the unit may be equipped with a “Count-down” timer 12 indicating run-time, start-time and end-time.

As shown in FIG. 1, the unit is equipped with an “Air-Flow” monitor that monitors air flow across the entire instrument tray. If air-flow is diminished below a specified threshold, a warning light 14 and audible alarm may be triggered and the treatment cycle can then be aborted. This information can be recorded, stored and printed by optional equipment of the apparatus.

As shown in FIG. 1, the unit is equipped with a “Cycle Terminate” panel 15 that can terminate the sterilization cycle and unlock the sterilization chamber door. Activation of this panel 15 triggers both a visual alarm and audible alarm and the printer can be activated recording, storing, and printing notification of the event.

As shown in FIG. 1, the unit is equipped with a locking door mechanism 18 (physical and/or magnetic) to preclude the ability to interrupt the sterilization cycle and retrieve an instrument before sterilization conditions have been achieved. The door 16 preferably has a thermally insulated handle to avoid the transfer of heat to the operator. Upon completion of the sterilization cycle, the controller deactivates the locking mechanism 18 to open the door 16 and allow removal of the tray 17 and/or instruments.

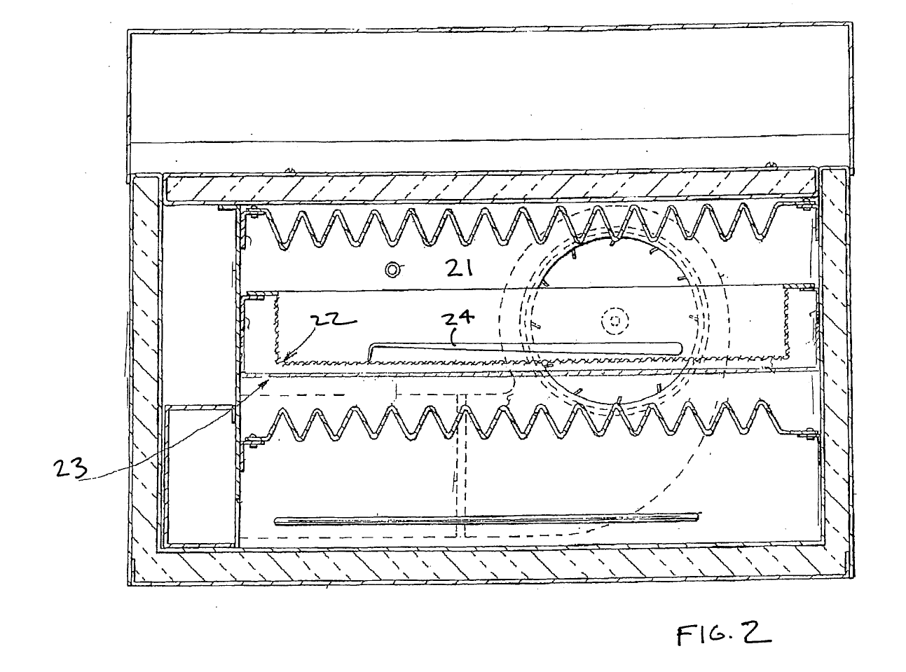

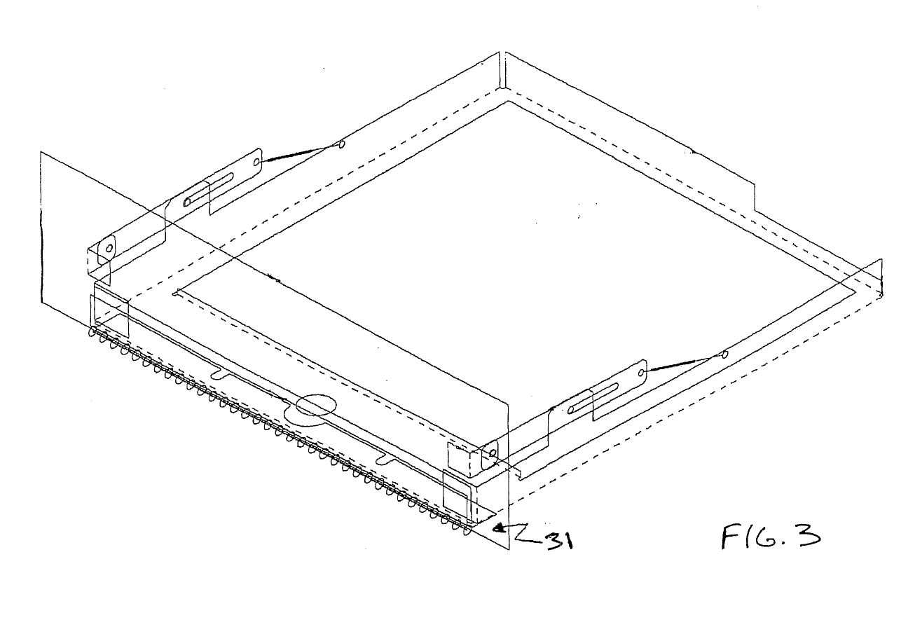

As shown in FIG. 2 and FIG. 3, the unit may be equipped with mechanism to assist the removal of the tray and/or instruments. The door 31 is attached to the internal sliding tray 22 and upon pulling the door 31 down into the open position, the tray 32 is partially pulled out of the sterilization chamber 21. Upon closing the door 31 by pushing the door 31 up, the internal sliding tray 22 is pushed into the sterilization chamber 21. The drawer shelf 23 is manufactured with a stainless steel mesh material that allows hot dry air to circulate over the items to be sterilized 24.

The unit may be equipped with telephone-connect diagnostics to assist trouble shooting equipment problems from remote locations or to transfer and store permanent record of performed treatment cycles at another location for equipment function and use documentation.

The unit may be provided with a dry heat biological culture set and/or biological indicators, sterilization bags, heat resistant gloves, instrument cooling plates, printers, or transport carts as optional accessories.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

What is claimed is:

1. A high velocity hot air sterilization device containing monitors, controls and devices that allow for the sterilization of medical, dental, or veterinary instruments or other devices that has the ability to:
a. provide a variety of pre-set time-temperature settings to preserve the material integrity and to meet sterilization requirements for instruments and devices of various metal and plastic compositions, both wrapped and unwrapped;
b. provide assurance that the pre-set treatment cycles are monitored, displayed, recorded, and printed;
c. provide assurance that the pre-set treatment cycles cannot be interrupted mid-cycle without audible and visible alarming; and
d. provide the mechanisms to automatically record and store permanent records of all sterilization cycles and their operating conditions.

2. A high velocity hot air sterilization device according to claim 1, wherein sterilization conditions ranging in temperature from 250° F. to 400° F. with corresponding established timeframe thresholds are pre-set into the programmable controller.

3. A high velocity hot air sterilization device according to claim 1 wherein the pre-set sterilization conditions are monitored by the programmable controller and displayed on the control panel for time, temperature, setting, and airflow.

4. A high velocity hot air sterilization device according to claim 1 wherein the sterilization door is locked by physical and/or magnetic means upon activation of a sterilization cycle and can only be disengaged through the activation of the “Cycle Terminate” panel.

5. A high velocity hot air sterilization device according to claim 1 wherein a “Cycle Terminate” panel can be activated to release the locked sterilization chamber door in the event the cycle requires interruption.

6. A high velocity hot air sterilization device according to claim 1, wherein the all sterilization cycles, complete or interrupted are recorded, stored, and printed containing sterilization setting, date, start-time, end-time, temperature at one-minute intervals, total treatment time, airflow rate, and notification of malfunction or incomplete event.

7. A high velocity hot air sterilization device according to claim 1, wherein the door to the sterilization chamber is connected to a sliding tray drawer allowing the drawer to be partially extended beyond the sterilization chamber and allowing the extended tray drawer to slide back into the sterilization chamber upon door closure.

8. A high velocity hot air sterilization device according to claim 1, wherein the programmable controller has the means for both direct temperature monitoring, the controller has the ability to monitor sensors such as thermocouples and non-contact temperature monitoring devices using infrared or other such sensors (Adjustable Irt/c.4ACF and c.8ACT model IR thermocouple sensors), including non-contact temperature sensors employed to monitor the surface temperature of instruments or instrument surrogates.

9. A high velocity hot air sterilization device according to claim 1, wherein the programmable controller provides programmable “Off” and “Resting” modes linked to an atomic clock to bring the sterilization device from off to resting to treatment temperature and to turn the unit down to “Resting” or “Off” mode at selective times automatically as programmed for each day of the week.

10. A high velocity hot air sterilization device according to claim 1, wherein the programmable controller is equipped to interact with telephone-connect diagnostics to assist trouble shooting equipment problems from remote locations or to transfer and store permanent record of performed treatment cycles at another location for equipment function and use documentation.
